(19) United States
(12) Patent Application Publication
(10) Pub. No.: US 2024/0244570 A1
(43) Pub. Date: Jul. 18, 2024

(54) DEVICE SELECTION FOR UE POSITIONING

(71) Applicant: QUALCOMM INCORPORATED, San Diego, CA (US)

(72) Inventors: Srinivas YERRAMALLI, San Diego, CA (US); Mukesh KUMAR, Hyderabad (IN); Alexandros MANOLAKOS, Escondido, CA (US)

(21) Appl. No.: 18/563,028

(22) PCT Filed: Jun. 15, 2022
(86) PCT No.: PCT/US2022/033692

§ 371 Date: Nov. 21, 2023

(30) Foreign Application Priority Data
Jul. 8, 2021 (GR) 20210100462

(51) Int. Cl. H04W 64/00; H04W 40/04

(52) U.S. Cl. CPC H04W 64/00; H04W 40/04

(57) ABSTRACT

A device selection method for positioning includes: determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and selecting, based on the one or more parameters, a device to perform the one or more positioning operations.

### CROSS-REFERENCE TO RELATED APPLICATIONS

This application claims the benefit of Greek Patent Application No. 20210100462, filed Jul. 8, 2021, entitled “DEVICE SELECTION FOR UE POSITIONING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example device selection method for positioning includes: determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and selecting, based on the one or more parameters, a device to perform the one or more positioning operations.

An example apparatus includes: a transceiver; a memory; and a processor communicatively coupled to the transceiver and the memory and configured to: determine one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and select, based on the one or more parameters, a device to perform the one or more positioning operations.

Another example apparatus includes: means for determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and means for selecting, based on the one or more parameters, a device to perform the one or more positioning operations.

An example non-transitory, processor-readable storage medium includes processor-readable instructions to cause a processor of an apparatus to: determine one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and select, based on the one or more parameters, a device to perform the one or more positioning operations.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of a user equipment.

FIG. 6 is a block diagram of a network entity.

FIG. 7 is a signaling and process flow of for selecting a device for performing one or more positioning operations, and determining position information.

FIG. 8 is a simplified diagram of a charging data record.

FIG. 9 is a simplified diagram of another charging data record.

FIG. 10 is a timing diagram of wake-up times and positioning reference signals.

FIG. 11 is another timing diagram of wake-up times and positioning reference signals.

FIG. 12 is another signaling and process flow for selecting a device for performing one or more positioning operations, and determining position information.

FIG. 13 is a simplified diagram of a user, a primary user equipment, and multiple secondary user equipments.

FIG. 14 is another signaling and process flow for selecting a device for performing one or more positioning operations, and determining position information.

FIG. 15 is a block flow diagram of a device selection method for positioning.

### DETAILED DESCRIPTION

Techniques are discussed herein for selecting a device to perform one or more positioning operations. For example, a user equipment (UE) that has multiple subscriber identification modules (SIMs) may choose which SIM to use to perform one or more operations for determining position information (e.g., positioning signal measurement(s), processed positioning signal measurement(s) such as range(s), and/or position estimate(s)) for the UE. The UE may choose between the SIMs based on one or more factors such as cost of performing the operation(s). For example, there may be different monetary costs associated with the different SIMs for performing the same operation(s). As another example, the different SIMs may provide different cost in the form of one or more different positioning characteristics (e.g., latencies, accuracies, etc.). As another example, the cost may be in terms of processing cost, e.g., if one of the SIMs is in idle mode or inactive mode and another one is in inactive mode or connected mode, or if both are in idle mode or inactive mode but wake-up times of the two idle modes or inactive modes having different timing relative to respective positioning reference signal configurations such that different processing power and/or time may be used to measure respective positioning reference signals by each of the SIMs. Another example technique for selecting a device to perform the positioning operation(s) involves multiple devices. For example, if a target UE whose location is desired is proximate to another UE, then the other UE may be used to determine a position estimate of the other UE and this position estimate used as a position estimate of the target UE. As yet another example, the target UE may determine cost (e.g., monetary cost) for transferring one or more sidelink signals with (e.g., transmitting one or more signals to and/or receiving one or more signals from) different peer UEs and select to transfer (e.g., transmit and/or receive) sidelink signaling to and/or from one peer UE over another peer UE based on different costs associated with the different peer UEs. These are examples, and other examples may be implemented.

Items and/or techniques described herein may provide one or more of the following capabilities, as well as other capabilities not mentioned. Cost for determining position of a mobile device, including tracking a mobile device, may be reduced and/or positioning accuracy and/or latency improved, e.g., by selecting from multiple options of devices (e.g., SIMs, UEs) for performing one or more positioning operations. Power consumption of a power-limited device for determining position information may be conserved, e.g., by leveraging one or more positioning operations performed by another device. Latency may be improved. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrow % band Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

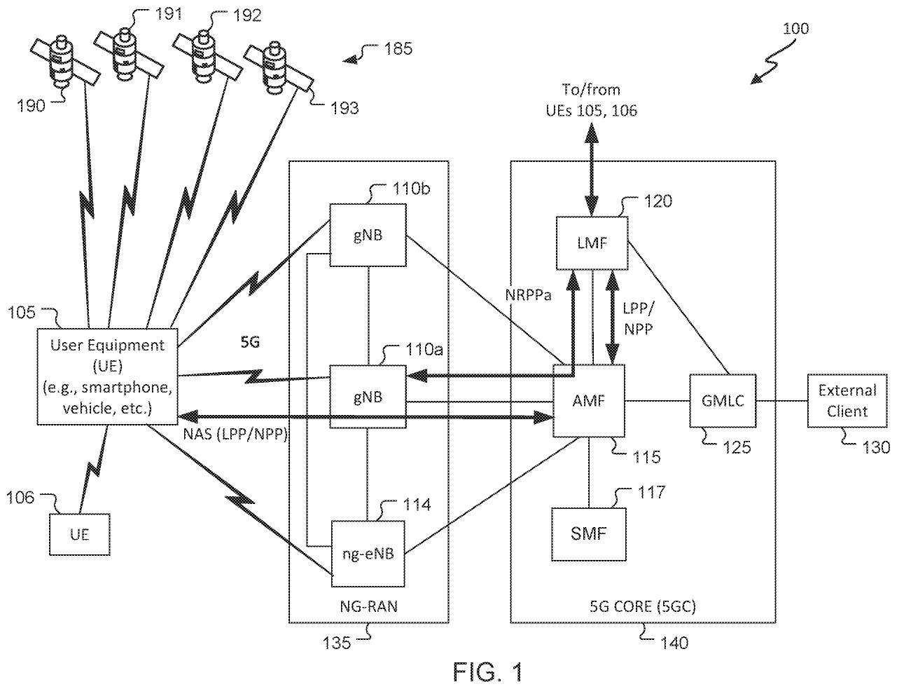

Referring to FIG. 1, an example of a communication system 100 includes a UE 105, a UE 106, a Radio Access Network (RAN), here a Fifth Generation (5G) Next Generation (NG) RAN (NG-RAN) 135, and a 5G Core Network (5GC) 140. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 10a, 10b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a. 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS (Synchronization Signals) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT. RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

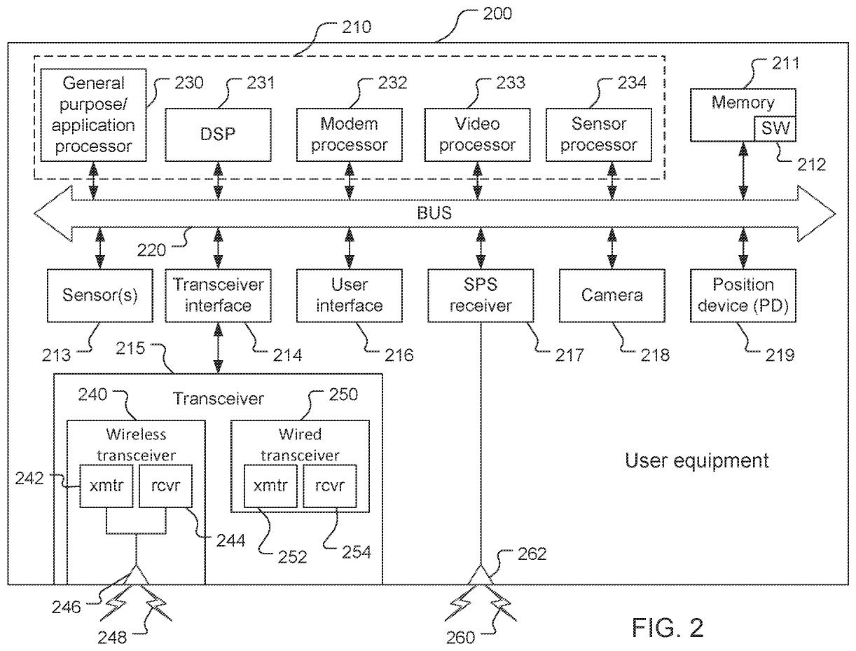

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

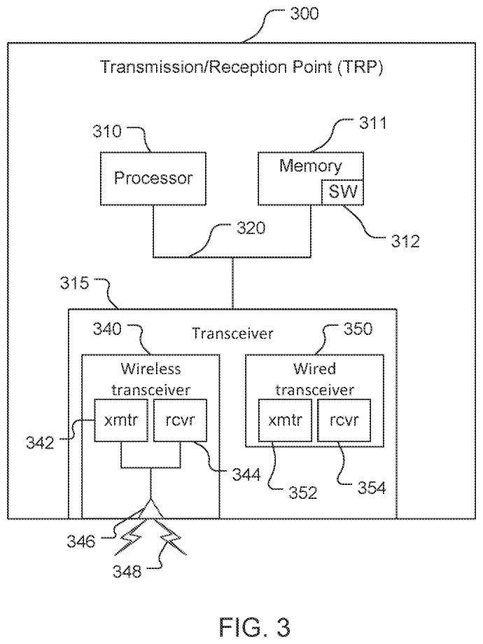

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

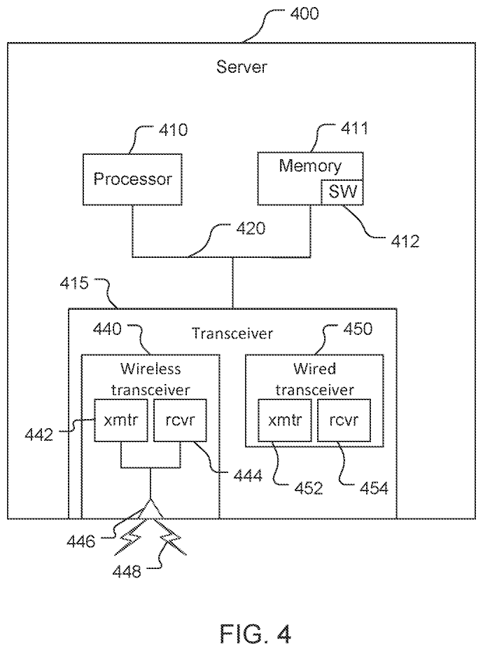

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information—Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nib resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured. e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods. UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Device Selection for Positioning

Devices may be selectively used for performing positioning operations for positioning of (determining position information for) a target UE. For example, one of multiple SIMs of the target UE may be selected to transfer (e.g., transmit and/or receive) positioning signals based on monetary cost and/or processing cost of use of each of the SIMs for the desired positioning. This may reduce expense, reduce battery usage, reduce latency, and/or improve positioning accuracy. As another example, one or more peer UEs may be selected for signal transfer with a target UE based on monetary cost that the peer UE(s) will pass to the target UE. This may reduce expense for positioning of the target UE using sidelink communications. As another example, a primary UE that is close to the target UE may be selected for performing positioning operations, e.g., providing position information including, or that may be used to determine, a position estimate of the primary UE that may be used as the position of the target UE. This may reduce battery usage by the target UE and/or improve positioning accuracy and/or latency by using the primary UE, which may have more processing capability (e.g., is able to process a more complex, more accurate positioning algorithm) than the target UE. Other examples are within the scope of the disclosure.

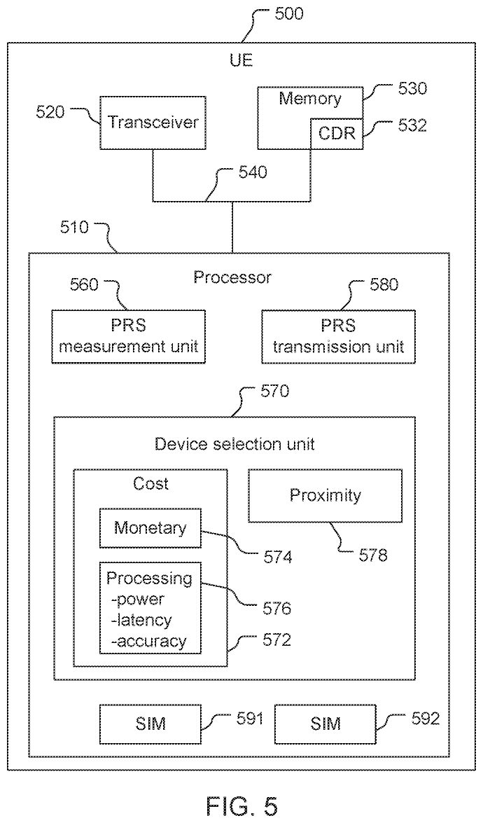

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The memory 530 may store a charging data record 532 (CDR). The UE 500 may be capable of receiving and/or transmitting wireless signals (e.g., DL-PRS, UL-PRS, SL-PRS), and may also be configured to transfer (e.g., transmit and/or receive) wired signals.

A location services (LCS) client or application function (AF) may or may not be authorized to retrieve a location of a UE, e.g., for commercial use. UE LCS privacy may allow a UE and/or an AF to control which LCS clients and/or AFs are and are not allowed access to UE location information. UE LCS privacy may be supported via subscription and via UE LCS privacy profile handling. With subscription, privacy preferences for a UE may be stored in a UE LCS privacy profile as part of UE subscription data in a UDM (Unified Data Management) and queried from the UDM by a network function (NF) such as a GMLC or a network exposure function (NEF).

The processor 510 includes SIMs 591, 592. The SIMs 591, 592 may comprise integrated circuits that are each configured to run a card operating system (COS) to store a respective international mobile subscriber identity (IMSI) and related key securely. The IMSI and the related key may be used to identify and authenticate a subscriber corresponding to each of the SIMs 591, 592, which may be the same subscriber.

The memory 530 may store the charging data record 532 (CDR). LCS services may incur charges and charges for corresponding services may be stored in a CDR such as the CDR 532. Charging information for LCS services may be collected at a network entity such as a GMLC or an AMF. For roaming, the charging information may be collected in both a home PLMN (Public Land Mobile Network) and a visited PLMN for inter-operator charging. The server 400 may store CDRs and may send messages (e.g., USSD (Unstructured Supplementary Service Data) packets) regarding amounts charged for services provided. The processor 510 may collect charging information from these messages to develop a look-up table (LUT) of LCS services/operations and corresponding charges at the CDR 532. The LCS charges may, for example, be based on positioning technology (e.g., satellite (e.g., GNSS) vs. terrestrial (e.g., NR)), positioning method (e.g., GNSS, OTDOA, ToA, RTT, etc.) to which a service corresponds, a quality of service, a delay tolerance level (e.g., low, medium, high), an accuracy level (e.g., low, medium, high), bandwidth used, an amount of resources used for a service or operation, etc. Content of the CDR 532 may depend on the operator(s) associated with the UE 500. Different operators (network service providers, e.g., Verizon®, AT&T®) may charge different amounts for the same service or same type of service. The same operator may charge different amounts corresponding to different SIMs (e.g., different UEs or the SIMs 591, 592 within the UE 500). For example, one SIM may have an unlimited plan such that positioning operations (e.g., PRS transfer, ToA measurement, RTT measurement, etc.) are pre-paid such that an additional charge is not incurred for each positioning operation performed, and another SIM may have a subscription plan that may incur a cost for each positioning request (e.g., using one or more positioning operations) or each positioning operation. Different charges may be incurred for the use of different communication links, e.g., use of a Uu link between the UE 500 and the TRP 300 compared to use of a sidelink between the UE 500 and another UE. The use of the Uu link may incur a lesser charge than use of the sidelink.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a PRS measurement unit 560, a device selection unit 570, and/or a PRS transmission unit 580. Depending on the implementation of the signaling UE 500, one or more of the units 560, 570, 580 may be omitted from the UE 500. The PRS measurement unit 560, the device selection unit 570, and the PRS transmission unit 580 are discussed further below, and the description may refer to the processor 510 generally, or the UE 500 generally, as performing any of the functions of the PRS measurement unit 560, the device selection unit 570, and/or the PRS transmission unit 580, with the UE 500 being configured to perform the functions.

The PRS measurement unit 560 and the PRS transmission unit 580 are configured to measure and transmit appropriate PRS. For example, the PRS measurement unit 560 may be configured to measure DL-PRS, UL-PRS, and/or SL-PRS and the PRS transmission unit 580 may be configured to transmit UL-PRS, DL-PRS, and/or SL-PRS. For example, if the UE 500 is a UE, then the PRS measurement unit 560 will likely be configured to measure DL-PRS and SL-PRS, and may be configured to measure UL-PRS, and the PRS transmission unit 580 will likely be configured to transmit UL-PRS and SL-PRS, and may be configured to transmit DL-PRS. As another example, if the UE 500 is a TRP or part of a base station, then the PRS measurement unit 560 will likely be configured to measure UL-PRS, and may be configured to measure DL-PRS and/or SL-PRS, and the PRS transmission unit 580 will likely be configured to transmit DL-PRS, and may be configured to transmit UL-PRS and/or SL-PRS. As another example, if the UE 500 is a standalone reference location device, then the PRS measurement unit 560 and the PRS transmission unit 580 may be configured similar to the configurations for the UE 500 being a UE.

Transfer and measurement of PRS may help with position determination of a mobile device, such as a UE, and/or with measurement calibration. For example, various PRS measurements may be used to support UE-assisted and/or UE-based position calculation using one or more of a variety of positioning techniques. For example, DL-PRS may be measured by the PRS measurement unit 560 to determine RSTD for DL-TDOA or to determined RSRP for DL-TDOA, DL-AoD, and/or multi-RTT techniques. As another example, DL-PRS and UL-PRS may be measured by the PRS measurement unit 560 to determine a UE Rx-Tx time difference for multi-RTT. As another example, SSB or CSI-RS (Channel State Information Reference Signal) for RRM (Radio Resource Management) may be measured by the PRS measurement unit 560 to determine SS-RSRP (Synchronization Signal RSRP for RRM), SS-RSRQ (for RRM), CSI-RSRP (for RRM), CSI-RSRQ (for RRM) for E-CID.

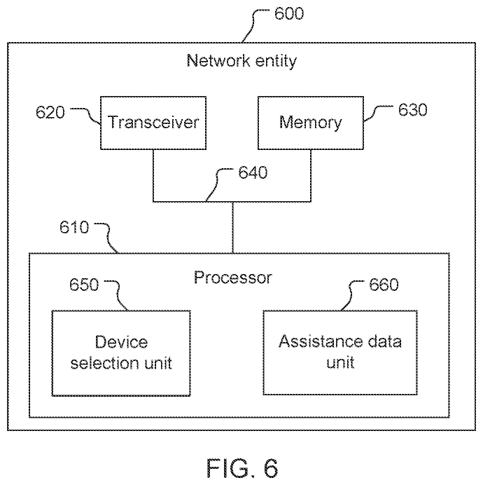

Referring also to FIG. 6, a network entity 600 includes a processor 610, a transceiver 620, and a memory 630 communicatively coupled to each other by a bus 640. The network entity 600 may include the components shown in FIG. 6. The network entity may include one or more other components such as any of those shown in FIG. 3 and/or FIG. 4 such that the TRP 300 and/or the server 400 may each be an example of the network entity 600. For example, the processor 610 may include one or more of the components of the processor 310 and/or the processor 410. The transceiver 620 may include one or more of the components of the transceiver 315 and/or the transceiver 415, e.g., the wireless transmitter 342 and the antenna 346, or the wireless receiver 344 and the antenna 346, or the wireless transmitter 342, the wireless receiver 344, and the antenna 346, and/or the wireless transmitter 442 and the antenna 446, or the wireless receiver 444 and the antenna 446, or the wireless transmitter 442, the wireless receiver 444, and the antenna 446. Also or alternatively, the transceiver 520 may include the wired transmitter 352 and/or the wired receiver 354, and/or the wired transmitter 452 and/or the wired receiver 454. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include a device selection unit 650 and/or an assistance data unit 660. Depending on the implementation of the network entity 600, one or more of the units 650, 660 may be omitted from the network entity 600. The device selection unit 650 and the assistance data unit 660 are discussed further below, and the description may refer to the processor 610 generally, or the network entity 600 generally, as performing any of the functions of the device selection unit 650 and/or the assistance data unit 660, with the network entity 600 configured to perform the functions.

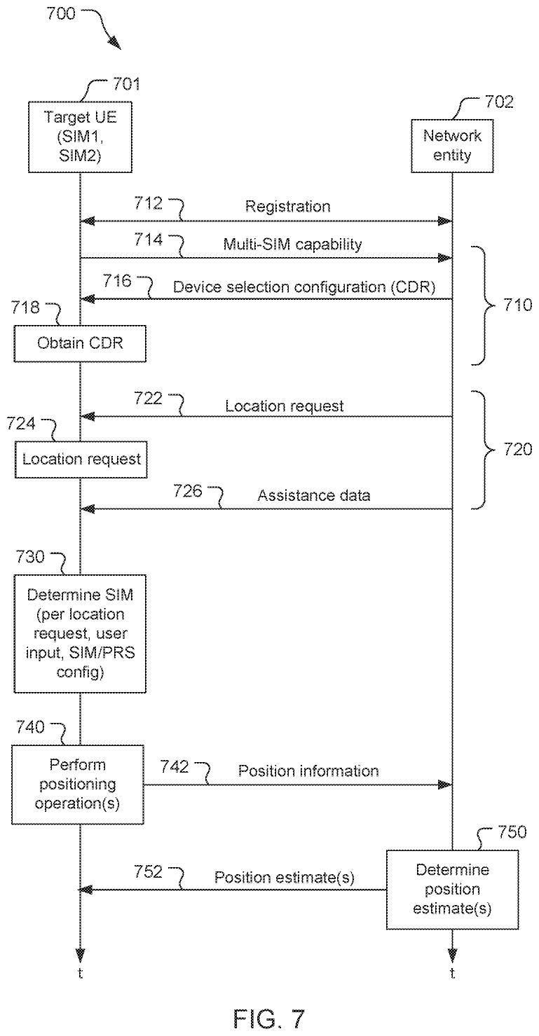

Referring to FIG. 7, with further reference to FIGS. 1-6, a signaling and process flow 700 for selecting a device (here a SIM of a target UE 701) for performing one or more positioning operations, and determining position information, includes the stages shown. The target UE 701 may be an example of the UE 500, although the target UE 701 may not include a proximity sub-unit of the device selection unit 570. The flow 700 is an example, as stages may be added, rearranged, and/or removed. For example, one or more of messages 714, 716 may be omitted. As another example, a location request 722 or a location request 724 may be omitted. As other examples, position information 742 may not be sent, a stage 750 may be omitted and/or one or more position estimates 752 may not be sent.

At stage 710, the target UE 701 obtains information for device (here, SIM) selection for performing one or more positioning operations. For example, the target UE 701 and a network entity 702 (which is an example of the network entity 600 and may include an LMF) may engage in registration 712 of the target UE 701 to the network associated with the network entity 702. The registration 712 includes transfer of registration communications (according to a NAS (Non-Access Stratum) signaling procedure) to register the SIMs 591, 592 with the network associated with the network entity 702, moving from RM-Deregistered (Registration Management deregistered) to RM-Registered. The target UE 701 may transmit a multi-SIM capability message 714 to the network entity 702. The message 714 may be part of a larger capability message. The message 714 indicates to the network entity 702 the identities of the SIMs 591, 592, indicating that the target UE 701 includes the SIMs 591, 592 and that the target UE 701 may use either or both of the SIMs 591, 592 for positioning of the target UE 701 (for determining one or more position estimates of the target UE 701). The network entity 702 may transmit a device selection configuration message 716 to the target UE 701. The message 716 may include one or more instructions for how the target UE 701 is to select, and/or one or more parameters for use in selecting, a device (e.g., one of the SIMs 591, 592) for positioning of the target UE 701. The message 716 may, for example, include a CDR indicating one or more monetary charges and possibly one or more corresponding criteria. e.g., one or more positioning operations, positioning technologies, positioning methods, communication links, etc. Also or alternatively, stage 710 may include sub-stage 718, where the target UE 701 obtains the CDR 532. Obtaining the CDR 532 may include determining the CDR 532 by compiling information over time from messages from the network entity 702 indicating charges for positioning services provided by the network entity 702. Obtaining the CDR 532 may include the processor 510 reading information from the CDR 532 stored in the memory 530.

At stage 720, a location request is received by the target UE 701 from an LCS client. For example, in a network-initiated location request, an LCS client in the network entity 702 may request a location of the target UE 701 and, in response, the network entity 702 (e.g., the processor 610) may transmit a location request 722 (e.g., via the transceiver 620) to the target UE 701. As another example, in a UE-initiated location request, an LCS client of the target UE 701 may produce a location request 724. The location request 722 and/or the location request 724 may request one or more position estimates for the target UE 701.

Also at stage 720, the network entity 702, e.g., the assistance data unit 660, provides assistance data 726 to the target UE 701. The assistance data 726 may include information to help the target UE 701 perform one or more positioning operations, e.g., measure PRS. The assistance data 726 may include an indication that the assistance data for one of the SIMs 591, 592 may be used by the other SIM 591, 592. For example, the network entity 702 may produce the assistance data 726 to indicate that the assistance data for the SIM 591 may be used by the SIM 592 based on the SIM 591 being in connected mode (and thus avoiding the SIM 592 waking up to decode a SIB (System Information Block) to obtain assistance data, which may save processing power and time). Also or alternatively, the network entity 702 may send the same assistance data (in the same message or different messages) to the SIMs 591, 592. The same assistance data may be used for the SIMs 591, 592 if the SIMs 591, 592 are associated with the same network through coordination of the network entity 702. The same assistance data may be used for the SIMs 591, 592 if the SIMs 591, 592 are associated with different networks with the network entity 702 comprising network entities associated with the different networks and the network entities coordinating with each other (e.g., according to an agreement such as a roaming agreement).

At stage 730, the target UE 701 determines a device, here a SIM, to perform one or more positioning operations for determining the location of the target UE 701. For example, a cost sub-unit 572 of the device selection unit 570 may be configured to determine a device based on cost (monetary and/or otherwise. e.g., processing cost). The device selection unit 570 may be configured to select one of the SIMs 591, 592 based on which of the SIMs 591, 592 provides a lower monetary cost, lower processing cost, or some combination thereof (e.g., a combination of monetary cost, processing power, positioning accuracy, and/or positioning latency). The device selection unit 570 may use one or more parameters indicative of cost (e.g., charging information, timing information regarding relative timing of PRS and wake-up times of the SIMs 591, 592, one or more accuracy criteria, one or more latency criteria, etc.).

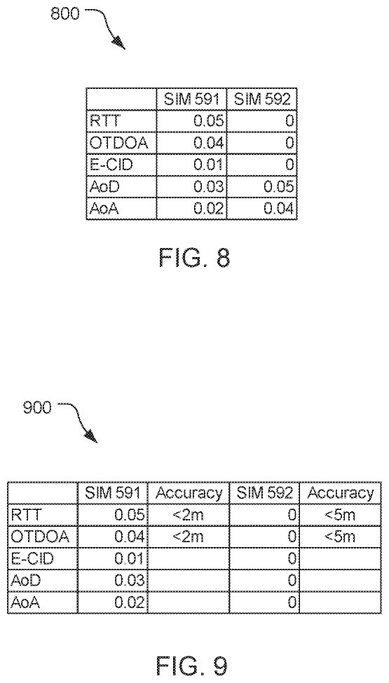

A monetary cost sub-unit 574 of the cost sub-unit 572 of the device selection unit 570 may be configured to determine the monetary cost, possibly in combination with a processing power sub-unit 576 determining a processing cost (e.g., processing power, positioning accuracy, latency, etc.) to use each of the SIMs 591, 592 to perform one or more positioning operations. The positioning operation(s) may comprise, for example, transferring PRS, measuring PRS, determining a processed measurement (e.g., a range, a position estimate), etc. For example, the device selection unit 570 may be configured to determine for which SIM there will be a lower LCS charge for a positioning session without regard to other factors. Referring also to FIG. 8, the device selection unit 570 may analyze a CDR 800 and determine that for the SIM 591, for RTT, OTDOA, or E-CID methods, there is a cost of $0.05, $0.04, or $0.01 per operation and that for SIM 592 there is no charge per operation for any of these methods. The device selection unit 570 may thus select the SIM 592 for any of these methods if the sole consideration is monetary cost. The device selection unit 570 may, however, select the SIM 592 for AoD or AoA methods as the monetary cost per operation for the SIM 591 is lower than for the SIM 592 for these methods. As another example, the device selection unit 570 may be configured to determine for which SIM there will be a lower LCS charge for a positioning session for at least a threshold accuracy (e.g., at least a minimum technology such as 4G). Referring also to FIG. 9, the device selection unit 570 may analyze a CDR 900 and select the SIM 591 based on an accuracy requirement of <3 m despite the SIM 591 having a higher monetary cost for either RTT or OTDOA because the SIM 591 can provide accuracy of less than 2 m for each of these methods. As another example, the device selection unit 570 may be configured to determine for which SIM there will be a lower LCS charge regardless of one or more other factors, e.g., selecting the SIM 591, 592 that will charge less for any positioning-related request, regardless of the positioning method to be used, accuracy to be provided, and/or whether the location request is received by the SIM 591 or the SIM 592. For example, as shown by the CDR 900, the SIM 591 has a per-operation charge plan and the SIM 592 has an unlimited plan (and thus additional charge will not be incurred for each use). In this case, the device selection unit 570 may favor and thus select the SIM 592 over the SIM 591 due to the SIM 592 having a lower monetary cost. As another example, the device selection unit 570 may, based on the CDR 900, select the SIM 591 if any other requirement(s) are to be met, such as accuracy threshold and/or latency threshold. As another example, the device selection unit 570 may be configured to select the SIM 591, 592 that will result in a lower charge with at least a threshold positioning accuracy. Thus, if the SIM 591 is more expensive than the SIM 592, but the SIM 592 cannot provide the threshold accuracy and the SIM 591 can, then the device selection unit 570 will select the SIM 591. The device selection unit 570 may use charging information obtained at stage 720 to determine the charges (if any) for each of the SIMs 591, 592 for the desired positioning operation(s). The charging information may be available in the upper layer for each SIM 591, 592, and the device selection unit 570 may select the SIM 591, 592 to be used based on the charging information (and/or other information as appropriate). Some applications may provide a constraint to use the SIM 591, 592 that is registered to a particular network for positioning while other applications may provide flexibility, allowing use of either of the SIMs 591, 592 regardless of whether the SIM 591, 592 is registered to a particular network.

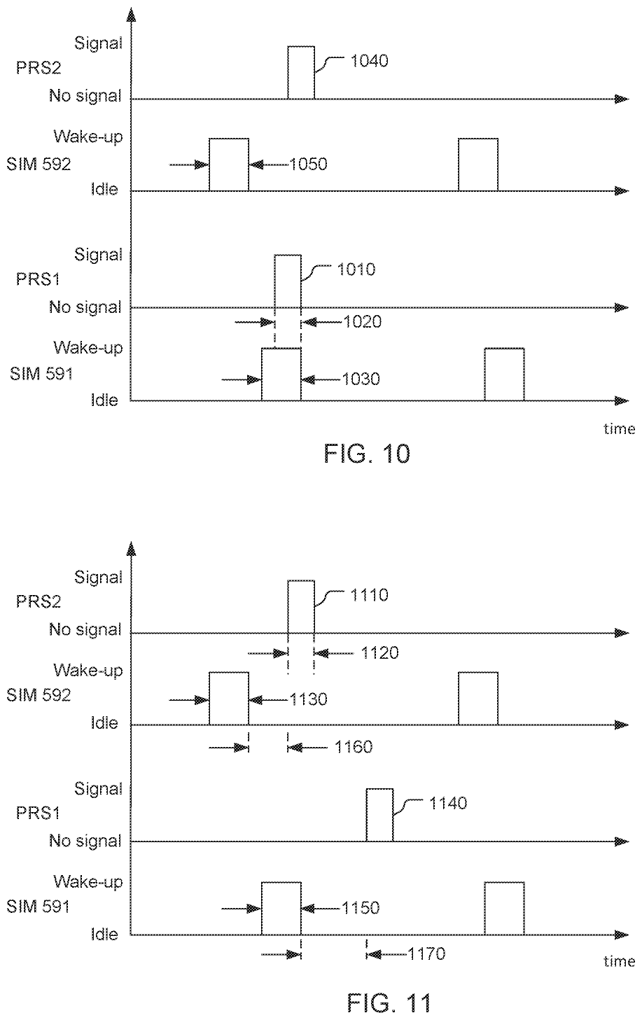

The device selection unit 570 may be configured to determine the processing cost, in terms of processing power to use each of the SIMs 591, 592 to perform one or more positioning operations, based on relationships between idle or inactive DRX configurations and PRS configurations, specifically the relative timings thereof. For example, the device selection unit 570 may be configured to select between the SIMs 591, 592 with both of the SIMs 591, 592 in idle DRX mode or both of the SIMs 591, 592 in inactive mode. The device selection unit 570 may select the SIM 591, 592 that has a respective PRS configuration closer to a respective DRX configuration, e.g., a PRS arrival within a DRX wake-up time, or a PRS arrival time nearer to a DRX wake-up time. Preference may thus be given to a device for which the corresponding PRS results in the lesser (or no) extension of a wake-up time in order to measure the PRS. For example, referring also to FIG. 10, the device selection unit 570 may select the SIM 591 based on an instance 1010 of PRS1, configured for the SIM 591, being scheduled to be received over a window 1020 that is within a wake-up time 1030 for the SIM 591 whereas an instance 1040 of PRS2, configured for the SIM 592, is scheduled to be received after a wake-up time 1050 for the SIM 592. As another example, referring also to FIG. 11, the device selection unit 570 may select the SIM 592 based on an instance 1110 of PRS2, configured for the SIM 592, being scheduled to be received over a window 1120 that is scheduled to be received closer in time to a wake-up time 1130 for the SIM 592 than an instance 1140 of PRS1 is scheduled to be received relative to a wake-up time 1150 for the SIM 591. That is, a time difference 1160 is smaller than a time difference 1170. In this way, the processing power used by the processor 510 to measure the instance 1110 may be less than the processing power used to measure the instance 1140, e.g., because the processor 510 may be kept on beyond the wake-up time 1130 for less time in order to measure the instance 1110 than to keep the processor on beyond the wake-up time 1150 to measure the instance 1140. The target UE 701 may request a change to the DRX cycle and/or the PRS configuration to help reduce the processing power to measure a PRS, e.g., if no PRS is scheduled to arrive within a threshold time of a wake-up time of one of the SIMs 591, 592. For example, the target UE 701 may send an RRC (Radio Resource Control) signal to the network entity 702 to request a change in the DRX cycle. As another example, the target UE 701 may use an on-demand framework to transmit a request to the network entity 702 for a change in the PRS configuration.

The target UE 500, e.g., the device selection unit 570, may be configured to select a device for positioning operation autonomously, based on configuration from the network entity 702, and/or based on user input. For example, the device selection unit 570 may select one of the SIMs 591, 592, e.g., by analyzing the CDR 532 for monetary cost and/or one or more other criteria such as processing cost. As another example, the device selection unit 570 may have a preference of one of the SIMs 591, 592 for any positioning, e.g., regardless of cost or other factors (accuracy, latency, etc.). As another example, the device selection unit 570 may select one of the SIMs 591, 592 based on a configuration from the network entity 702, e.g., in the device selection configuration message 716 or from the location request 722 being directed to a selected one of the SIMs 591, 592. The network entity 702 may route the location request 722 to a particular one of the SIMs 591, 592 based, for example, on the network entity 702 knowing that the target UE 701 includes the SIMs 591, 592 and based on one or more factors. For example, the network entity 702, e.g., the device selection unit 650, may be configured to determine that one of the SIMs 591, 592 is in idle mode or inactive mode and another of the SIMs 591, 592 is in connected mode, or that one of the SIMs 591, 592 is in idle mode and another of the SIMs 591, 592 is in inactive mode, when the network entity 702 receives a location request for the target UE 701. The device selection unit 650 may select the SIM 591, 592 that is in connected mode in the former example, and the SIM 591, 592 that is in the inactive mode in the latter example, to perform one or more positioning operations. This may save processing power and reduce latency compared to using a SIM that is in idle or inactive mode in the former example, or in idle mode in the latter example, by avoiding time and power that would be used to transition to connected mode and thus reducing time to begin, and reducing power to enable, performing the positioning operation(s). As another example, the target UE 500 may provide information regarding device selection to a user of the target UE 701 via the user interface 216, and receive a device selection from the user via the user interface 216. For example, the device selection unit 570 may provide a prompt on a display of the user interface asking the user to select a device, e.g., one of the SIMs 591, 592 (although the prompt may not identify the SIMs 591, 592). The prompt may include information upon which the user may base a device selection, e.g., monetary cost for performing one or more positioning operations (e.g., a cost to determine a position estimate), accuracy of expected position estimate, etc. The user may select a device, e.g., indicating one or more parameters (e.g., monetary cost and/or accuracy) that correspond (alone or in combination) with one of the SIMs 591, 592. The selection by the user may be a verbal command (e.g., “Use option A” or “Use the cheapest option” or “Accuracy of less than one meter”), a tactile command (e.g., touching of a portion of a display, pushing of a button, etc.), etc.

At stage 740, the target UE 701 performs one or more positioning operations to determine position information (e.g., PRS measurement, range, position estimate, etc.). The selected SIM 591, 592 performs the positioning operation(s), e.g., signal transfer, signal measurement, signal measurement processing, etc. For example, the PRS measurement unit 560 may measure one or more inbound PRS (e.g., DL-PRS, SL-PRS), and/or the PRS transmission unit 580 may transmit one or more outbound PRS (e.g., UL-PRS, SL-PRS). The target UE 701 may transmit position information 742 to the network entity 702.

At stage 750, the network entity 702 determines one or more position estimates based on the position information 742. For example, the processor 610 may use one or more PRS measurements, one or more indications of UE_{Rx-Tx}, one or more ranges, etc. to determine one or more position estimates for the target UE 701 based on one or more positioning methods. The network entity 702 may send one or more position estimate(s) 752 to the target UE 701, e.g., if the LCS client is in the target UE 701. The network entity 702 may provide one or more position estimates to both of the SIMs 591, 592 even though the position estimate(s) is(are) determined for one of the SIMs 591, 592. For example, if the SIM 591 is in a positioning session, the network entity 702 may provide one or more position estimate(s), determined based on operation of the SIM 591, to the SIM 592 in response to a location request for the SIM 592. This may save significant time, processing power, and/or monetary cost to determine a position estimate for the SIM 592.

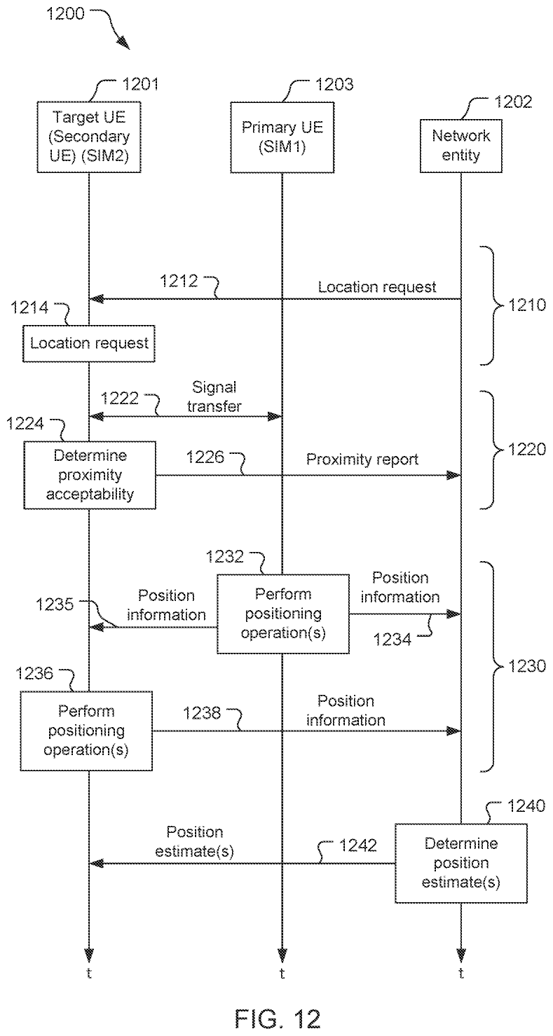

Referring to FIG. 12, with further reference to FIGS. 1-7, a signaling and process flow 1200 for selecting a device (here a UE with a corresponding SIM) for performing one or more positioning operations, and determining position information, includes the stages shown. The flow 1200 is an example, as stages may be added, rearranged, and/or removed. For example, one of location requests 1212 or 1214 may be omitted. As other examples, position information 1234 or 1238 may not be sent, and/or one or more position estimates 1242 may not be sent.

At stage 1210, a location request is received by a target UE 1201 from an LCS client. For example, in a network-initiated location request, an LCS client in the network entity 1202 may request a location of the target UE 1201 and, in response, the network entity 1202 (e.g., the processor 610) may transmit a location request 1212 (e.g., via the transceiver 620) to the target UE 1201. As another example, in a UE-initiated location request, an LCS client of the target UE 1201 may produce a location request 1214. The location request 1212 and/or the location request 1214 may request one or more position estimates for the target UE 1201. The location request 1212 may request the location of the target UE 1201 and may request a proximity of the target UE 1201 to a primary UE 1203, e.g., an indication of whether the target UE 1201 is within a threshold distance of the primary UE 1203. The location request 1212 may, however, instruct the target UE 1201 to perform one or more positioning operations without determining proximity of the target UE 1201 to the primary UE 1203. The target UE 1201 may be an example of the UE 500, although the target UE 1201 may not include the cost sub-unit 572 and may not include the SIM 592.

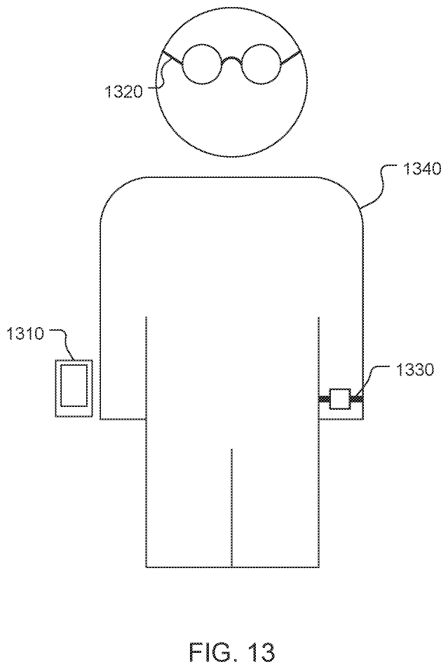

At stage 1220, a proximity of the target UE 1201, which is a secondary UE, to the primary UE 1203 is determined and possibly reported to the network entity 1202. The primary UE 1203 and the target UE 1201 include respective SIMs (here SIM1 and SIM2). The primary UE 1203, which may be an example of the UE 500, although the primary UE 1203 may include a single SIM (e.g., may not include the SIM 592) and may not include the device selection unit 570, may be a device with significant processing power and significant battery power for determining position information for the primary UE 1203. For example, referring also to FIG. 13, the primary UE 1203 may be a smartphone 1310, a tablet computer, etc. The target UE 1201 may be configured to determine position information for the target UE 1201 and have less processing and/or battery power than the primary UE 1203. For example, the target UE 1201 may be an IoT (Internet of Things) device such as smart glasses 1320, a smartwatch 1330 (worn by a user 1340), etc. For use in determining whether the primary UE 1203 is within an acceptable proximity of the target UE 1201, the target UE 1201 and the primary UE 1203 may engage in a signal transfer 1222. For example, the target UE 1201 and the primary UE 1203 may transfer SL-PRS (here, transmit and receive SL-PRS). As another example, the target UE 1201 may transmit (e.g., broadcast) an inquiry message using a short-range wireless protocol (e.g., Bluetooth®) signal. At sub-stage 1224, a proximity sub-unit 578 of the device selection unit 570 of the target UE 1201 may determine whether the primary UE 1203 is within an acceptable proximity of the target UE 1201. For example, the proximity sub-unit 578 may determine an RTT and thus a range between the target UE 1201 and the primary UE 1203 based on the signal transfer 1222. The proximity sub-unit 578 may determine whether the range between the target UE 1201 and the primary UE 1203 is within an acceptable proximity, e.g., within a threshold distance. Also or alternatively, the proximity sub-unit 578 may determine whether the target UE 1201 receives a response to the inquiry message, and if so, the proximity sub-unit 578 may conclude that the primary UE 1203 is within an acceptable proximity of the target UE 1201 (with the range of the short-range wireless protocol being an acceptable proximity). The primary UE 1203 may also or alternatively determine the proximity (and the acceptableness of the proximity) of the target UE 1201 and the primary UE 1203.

The target UE 1201 and/or the primary UE 1203 may report to the network entity 1202 regarding the results of the proximity inquiry. For example, the target UE 1201 may transmit a proximity report 1226 to the network entity 1202 indicating whether the target UE 1201 and the primary UE 1203 are within an acceptable proximity. The proximity report 1226 may, for example, include a Boolean indication of proximity, e.g., “0” for not within a proximity threshold and “1” for within the proximity threshold. The proximity report 1226 may indicate a distance between the target UE 1201 and the primary UE 1203, if determined. The target UE 1201 may transmit the proximity report 1226 if the proximity is acceptable, and otherwise not transmit the proximity report 1226. The indication that the proximity is acceptable may serve as an implicit indication that the primary UE 1203 will provide position information (e.g., instead of the target UE 1201 doing so) to the network entity 1202. Also or alternatively, the proximity report 1226 may explicitly indicate that the primary UE 1203 will provide position information (e.g., instead of the target UE 1201 doing so) to the network entity 1202.

At stage 1230, position information is determined and reported to the network entity 1202. For example, at sub-stage 1232, the primary UE 1203 (e.g., the PRS measurement unit 560) may determine position information such as one or more PRS measurements. The processor 510 of the primary UE 1203 may process the PRS measurement(s) into other position information (e.g., one or more ranges, one or more position estimates, etc.). The primary UE 1203 may transmit position information 1234 determined by the primary UE 1203 to the network entity 1202. The position information 1234 for the primary UE 1203 may be used in lieu of position information for the target UE 1201, e.g., such that the location of the primary UE 1203 may be used as an acceptable approximation of the location of the target UE 1201. The target UE 1201 may abstain from performing one or more positioning operations, which may save processing and battery power of the target UE 1201. The primary UE 1203 may be able to determine a more accurate position estimate, and/or provide more accurate position information from which a more accurate position estimate may be determined, than the target UE 1201, thus improving the positioning accuracy determined for the target UE 1201. The primary UE 1203 may provide position information 1235 to the target UE 1201. The position information 1235 may include, for example, distance information regarding a distance between the primary UE 1203 and the target UE 1201, a location of the primary UE 1203, a direction between the primary UE 1203 and the target UE 1201, etc. Also or alternatively, at sub-stage 1236, the target UE 1201 may perform one or more positioning operations to determine position information for the target UE 1201. For example, if the target UE 1201 is unable to verify that the target UE 1201 is within an acceptable proximity of the primary UE 1203, then the target UE 1201 (e.g., the PRS measurement unit 560, possibly in conjunction with other portions of the processor 510 of the target UE 1201) may determine position information for the target UE 1201. As another example, the target UE 1201 may determine position information for the target UE 1201 regardless of the proximity of the target UE 1201 and the primary UE 1203, e.g., based on an instruction to do so. e.g., based on an instruction contained in the location request 1212. The target UE 1201 may transmit determined position information 1238 for the target UE 1201 to the network entity 1202.

At stage 1240, the network entity 1202 may determine one or more position estimates for the target UE 1201 and/or for the primary UE 1203 depending on what position information the network entity 1202 received at stage 1230. The network entity 1202 may transmit the position estimate(s) 1242 to the target UE 1201.

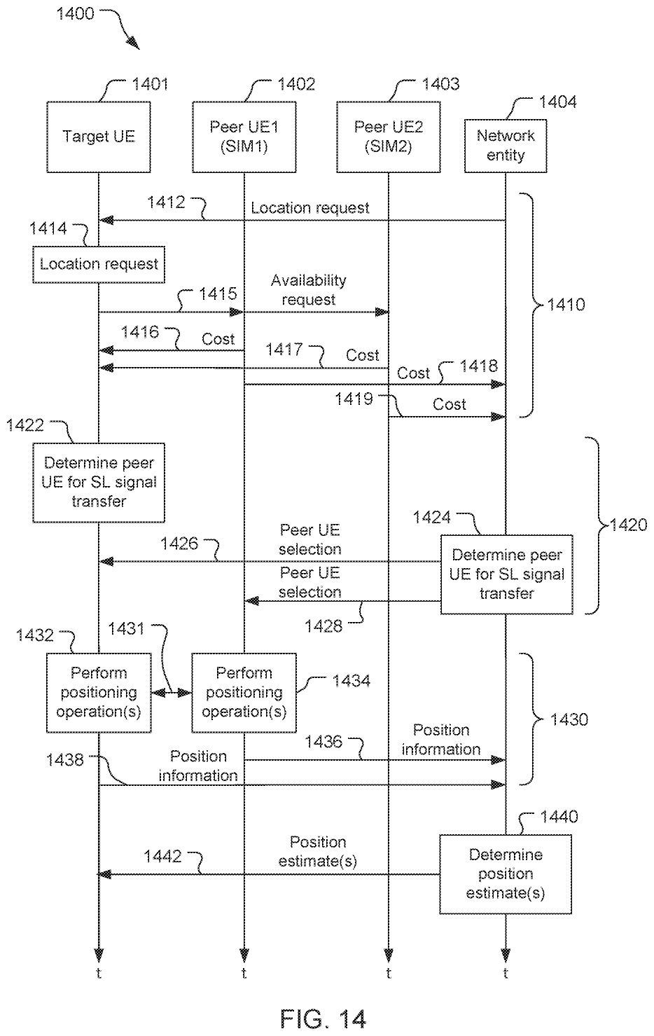

Referring to FIG. 14, with further reference to FIGS. 1-7, a signaling and process flow 1400 for selecting a device (here a SL peer UE with a corresponding SIM) for performing one or more positioning operations, and determining position information, includes the stages shown. The flow 1400 is an example, as stages may be added, rearranged, and/or removed. The flow 1400 is applicable to scenarios other than that shown. For example, while the flow 1400 shows two peer UEs, the flow 1400 is applicable in scenarios where more than two peer UEs are present and a target UE selects one or more of the peer UEs for use in positioning of the target UE.

At stage 1410, a location request is received by a target UE 1401 (which is an example of the UE 500 although possibly not including the cost sub-unit 572 or the proximity sub-unit 578) from an LCS client. For example, in a network-initiated location request, an LCS client in a network entity 1404 (which is an example of the network entity 600, although possibly not including the device selection unit 650 or the assistance data unit 660) may request a location of the target UE 1401 and, in response, the network entity 1404 (e.g., the processor 610) may transmit a location request 1412 (e.g., via the transceiver 620) to the target UE 1401. As another example, in a UE-initiated location request, an LCS client of the target UE 1401 may produce a location request 1414. The location request 1412 and/or the location request 1414 may request one or more position estimates for the target UE 1401. In response to the location request 1412, 1414, the target UE 1401 may transmit (e.g., broadcast) an availability request 1415. The availability request 1415 may be a SL message inquiring as to which peer UEs are available and willing to participate in positioning for the target UE 1401. Also at stage 1410, in response to the availability request 1415, peer UEs 1402, 1403 may transmit cost messages 1416, 1417, respectively, to the target UE 1401. The peer UEs 1402, 1403 may be examples of the UE 500, although possibly not including the device selection unit 570. The peer UEs 1402, 1403 may transmit the cost messages 1416, 1417 to the target UE 1401 via SL connections. The cost messages 1416, 1417 indicate the monetary costs to be incurred by use of the peer UEs 1402, 1403 in a positioning session. The cost messages 1416, 1417 may include monetary cost information such as charging information (e.g., a CDR such as information from the CDR 800 or the CDR 900 for the respective peer UE 1402, 1403), and possibly one or more corresponding criteria, e.g., type of signal transfer, type of positioning operation, positioning technology(ies), positioning method(s), communication link(s), etc., for the respective peer UE 1402, 1403. Different UEs may charge different amounts or otherwise have different amounts charged for operations performed by the different UEs. For example, a public UE (e.g., a public WiFi access point) may be used for SL signal transfer for positioning without incurring any monetary costs. A public UE may, for example, be a reference UE or a fixed relay. As another example, a private UE may be used for SL signal transfer for positioning for a charge, e.g., to the private UE that the private UE may pass on to a requesting UE, e.g., the target UE 1401. The private UE may have one or more higher-performance operational characteristics than a public UE, e.g., higher bandwidth than a public UE, better measurement and/or positioning accuracy than a public UE, etc. The peer UEs 1402, 1403 may also or alternatively send cost messages 1418, 1419 to the network entity 1404, with the cost messages 1418, 1419 indicating similar information as the cost messages 1416, 1417 such that the network entity 1404 may be able to select, based on cost, which of the peer UEs 1402, 1403 to use for positioning of the target UE 1401.

At stage 1420, one of the peer UEs 1402, 1403 is selected for use in positioning of the target UE 1401. For example, at sub-stage 1422, the target UE 1401 may determine one of the peer UEs 1402, 1403 for use in transferring SL signals between the selected UE and the target UE 1401 for use in determining position information for the target UE 1401. The target UE 1401 may determine the peer UE(s) that best meet one or more positioning criteria (e.g., monetary cost, accuracy, latency, etc.) for the target UE 1401 (e.g., as indicated by an LCS client requesting the location of the target UE 1401). For example, the device selection unit 570 of the target UE 1401 may be configured to give preference to a lower-cost UE, e.g., a public UE over a private UE. The preference of the target UE 1401 may be statically configured (e.g., by programming during manufacture of the target UE 1401, and/or dynamically configured, e.g., by reading an instruction received via the transceiver 520). A dynamic configuration may change (e.g., override) a prior (e.g., static) configuration either temporarily or permanently (subject to a later dynamic configuration). The dynamic configuration may come from the LCS client requesting the location of the target UE 1401. The preference may be based on cost (e.g., monetary and/or processing (e.g., accuracy, latency)). The target UE 1401 may be configured with a preference to use exclusively public UEs for SL signal transfer for positioning, or may be configured with a preference to use exclusively private UEs for SL signal transfer for positioning, or may be configured with a preference to use either public UEs or private UEs for SL signal transfer for positioning. If the target UE 1401 is configured with a preference to use either public or private UEs for SL signal transfer for positioning, then the target UE 1401 may be configured to select whether to use a UE for SL signal transfer for positioning based on one or more other criteria (e.g., accuracy providable, latency providable, etc.). At sub-stage 1424, the network entity 1404 may determine one of the peer UEs 1402, 1403 for use in transferring SL signals with (e.g., transmitting to and/or receiving from) the target UE 1401 for use in determining position information for the target UE 1401, e.g., as discussed above with respect to the sub-stage 1422 with the target UE 1401 making this determination. If the network entity 1404 determines the peer UE selection, then the network entity 1404 transmits a peer UE selection message 1426 to the target UE 1401 indicating the selected peer UE, and transmits a peer UE selection message 1428 to the selected peer UE, in this example the peer UE 1402, indicating that the selected peer UE has been selected and should transfer positioning signal(s) with (e.g., transmit to and/or receive from) the target UE 1401.

At stage 1430, position information is determined and reported to the network entity 1404. For example, the target UE 1401 and the peer UE(s) that was (were) selected at stage 1420, here the peer UE 1402, transfer one or more positioning signals 1431, here SL-PRS. At sub-stage 1432, the target UE 1401 performs one or more positioning operations, e.g., transmitting outbound SL-PRS to the peer UE 1402, measuring inbound SL-PRS from the peer UE 1402, determining position information from one or more SL-PRS measurements, etc. At sub-stage 1434, the peer UE 1402 performs one or more positioning operations, e.g., transmitting outbound SL-PRS to the target UE 1401, measuring inbound SL-PRS from the target UE 1401, determining position information from one or more SL-PRS measurements, etc. The peer UE 1402 may transmit position information 1436 to the network entity 1404 and/or the target UE 1401 may transmit position information 1438 to the network entity 1404. By using the peer UE(s) selected at stage 1420, based on cost and possibly one or more other factors, for performing one or more positioning operations, cost may be reduced compared to using one or more other peer UEs, and one or more other factors, e.g., positioning accuracy, may be improved.

At stage 1440, the network entity 1404 may determine one or more position estimates for the target UE 1401 based on the position information 1436, 1438 the network entity 1404 received at stage 1430. The network entity 1404 may transmit one or more position estimates 1442 to the target UE 1401.

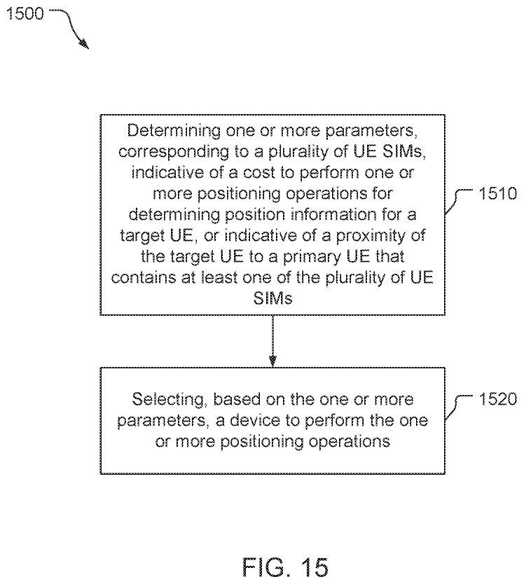

Referring to FIG. 15, with further reference to FIGS. 1-14, a device selection method 1500 for positioning includes the stages shown. The method 1500 is, however, an example and not limiting. The method 1500 may be altered, e.g., by having stages added, removed, rearranged, combined, performed concurrently, and/or having single stages split into multiple stages.

At stage 1510, the method 1500 includes determining one or more parameters, corresponding to a plurality of UE SIMs, indicative of a cost to perform one or more positioning operations for determining position information for a target UE, or indicative of a proximity of the target UE to a primary UE that contains at least one of the plurality of UE SIMs. For example, the UE 500 may determine monetary costs associated with each of the SIMs 591, 592 of the UE 500, e.g., by receiving and reading CDRs for the SIMs 591, 592, or by reading CDRs for the SIMs 591, 592 from the memory 530. As another example, the UE 500 may determine processing cost associated with each of the SIMs 591, 592 for performing one or more positioning operations, e.g., processing power to measure PRS based on relative timing of wake-up times and PRS arrival times. As another example, the network entity 600 (e.g., the device selection unit 650) may determine that one of the SIMs 591, 592 is in an idle mode or inactive mode and the other of the SIMs 591, 592 is in a connected mode, or that one of the SIMs 591, 592 is in an idle mode and the other of the SIMs 591, 592 is in an inactive mode, indicative of a processing cost differential for performing one or more positioning operations (e.g., measuring PRS) using the different SIMs 591, 592. As another example, the UE 500 may determine a proximity of another UE (with a corresponding SIM) to the UE 500 (e.g., with the SIM 591), e.g., as discussed with respect to stage 1220. As another example, the UE 500 may determine a peer UE that is within SL communication range and available and willing to perform the positioning operation(s). The processor 510, possibly in combination with the memory 530, possibly in combination with the transceiver 520 (e.g., the wireless receiver 244 and the antenna 246, or the wireless transmitter 242, the wireless receiver 244, and the antenna 246) may comprise means for determining the one or more parameters. The processor 610, possibly in combination with the memory 630, possibly in combination with the transceiver 620 may comprise means for determining the one or more parameters.

At stage 1520, the method 1500 includes selecting, based on the one or more parameters, a device to perform the one or more positioning operations. For example, the device selection unit 570 of the UE 500 may select one of the SIMs 591, 592 to measure PRS, transmit PRS, etc. based on which of the SIMs 591, 592 will perform the operation(s) with lower monetary cost, e.g., monetary cost specifically for performing the operation(s) in this instance (e.g., to satisfy a present location request). As another example, the device selection unit 570 may select a primary UE, e.g., the primary UE 1203, to perform the positioning operation(s) based on the primary UE 1203 being acceptably close to the UE 500. As another example, the device selection unit 570 may select one or more peer UEs for SL-PRS transfer with the UE 500 based on the peer UE(s) that is(are) in SL range of the UE 500 and available and willing to perform SL-PRS transfer (and possibly one or more other positioning operations). As another example, the device selection unit 650 of the network entity 600 may select one of the SIMs 591, 592 that is in connected mode based on the other of the SIMs 591, 592 being in idle mode or inactive mode, or may select one of the SIMs 591, 592 that is in an inactive mode based on the other of the SIMs 591, 592 being in idle mode. As another example, the device selection unit 650 of the network entity 600 may select a primary UE to perform the operation(s) based on the proximity of the primary UE to the UE 500. The processor 510, possibly in combination with the memory 530, may comprise means for selecting the device. The processor 610, possibly in combination with the memory 630, may comprise means for selecting the device.

Implementations of the method 1500 may include one or more of the following features. In an example implementation, the one or more parameters are indicative of the cost to perform the one or more positioning operations, and the cost to perform one or more position operations comprises a monetary cost. For example, the device selection unit 570 may retrieve monetary costs (e.g., CDRs) from the memory 530 (e.g., that the processor 510 determined over time) and/or receive monetary costs via the transceiver 520, e.g., wirelessly via a sidelink communication from another UE or via a downlink communication from the TRP 300. The monetary costs may be for multiple SIMs of the UE 500 or for SIMs outside of the UE 500 (e.g., associated with multiple other UEs). In another example implementation, the one or more parameters are indicative of the cost to perform the one or more positioning operations, and the cost to perform one or more position operations comprises a power consumption of the target UE. In another example implementation, the one or more parameters are indicative of the cost to perform the one or more positioning operations, the method further includes receiving, at a network entity from the target UE, an indication that the target UE includes the plurality of UE SIMs, and selecting the device to perform the one or more positioning operations comprises routing a location request to one of the plurality of UE SIMs. For example, the device selection unit 650 of the network entity 702 may receive the multi-SIM capability message 714 from the target UE 701 indicating that the target UE 701 includes the SIMs 591, 592. The device selection unit 650 may determine a cost of using each of the SIMs 591, 592 and route the location request 722 accordingly. e.g., to the SIM 591, 592 that is less costly, e.g., less expensive and/or has less associated processing cost). The processor 610, possibly in combination with the memory 630, in combination with the transceiver 620 (e.g., a wireless receiver and an antenna, or a wired receiver) may comprise means for receiving the indication that the target UE includes the plurality of SIMs. The processor 610, possibly in combination with the memory 630, in combination with the transceiver 620 (e.g., a wireless transmitter and an antenna, or a wired transmitter) may comprise means for routing the location request. In another example implementation, the one or more parameters are indicative of whether each of the plurality of UE SIMs, that are included in the target UE, is in an idle mode or an inactive mode or a connected mode, and the location request is routed to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode. For example, determining the one or more parameters may include receiving a message at the network entity 702 indicating the idle/inactive/connected status of each of the SIMs 591, 592. The device selection unit 650 may determine a cost of using each of the SIMs 591, 592 (e.g., a processing cost due to the idle mode status, inactive mode status, and connected mode status of the SIMs 591, 592) and route the location request 722 accordingly, e.g., based on which of the SIMs 591, 592 is in the connected mode or in the inactive mode if neither is in the connected mode, and possibly based on one or more other factors, e.g., monetary cost, accuracy, latency, etc.

Also or alternatively, implementations of the method 1500 may include one or more of the following features. In an example implementation, the one or more parameters are indicative of the cost to perform the one or more positioning operations, and the one or more parameters are indicative, for each of the plurality of UE SIMs, of a respective idle mode discontinuous reception configuration and a respective positioning reference signal configuration. For example, the one or more parameters may be timing of one or more idle mode DRX wake-up times and one or more PRS reception times (e.g., PRS instance reception time(s)), such as the times corresponding to instances 1010, 1040 and wake-up times 1030, 1050, and/or may indicate timing of the idle more DRX wake-up time(s) relative to the PRS reception time(s), e.g., indicating the time differences 1160, 1170. In another example implementation, the target UE includes the plurality of UE SIMs including a first SIM and a second SIM, and selecting the device to perform the one or more positioning operations comprises selecting the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM. For example, the device selection unit 570 and/or the device selection unit 650 may select the SIM 591, 592 that has a PRS instance arrive during a wake-up time (e.g., the SIM 591 in the example shown in FIG. 10) or the SIM corresponding to the PRS instance that arrives closer in time to a respective wake-up time (e.g., the SIM 592 in the example shown in FIG. 11). The processor 510, possibly in combination with the memory 530, may comprise means for selecting the first SIM. The processor 610, possibly in combination with the memory 630, may comprise means for selecting the first SIM.

Also or alternatively, implementations of the method 1500 may include one or more of the following features. In an example implementation, determining the one or more parameters comprises the target UE determining that the primary UE is within a threshold distance of the target UE, and the method 1500 further comprises reporting, from the target UE to a network entity, that the primary UE is within the threshold distance of the target UE. For example, at stage 1220 of the flow 1200, the target UE 1201 performs the signal transfer 1222 with the primary UE 1203 and determines, at sub-stage 1224 based on the signal transfer 1222, whether the primary UE 1203 is within an acceptable proximity of the target UE 1201 and sends the report 1226 indicating whether the primary UE 1203 is within the acceptable proximity of the target UE 1201. For example, at sub-stage 1224 the target UE 1201 may determine that the primary UE 1203 is within an acceptable proximity of the target UE 1201 and send the report 1226 indicating that the primary UE 1203 is within the acceptable proximity of the target UE 1201. The processor 510, possibly in combination with the memory 530, in combination with the transceiver 520 (e.g., the wireless transmitter 242, the wireless receiver 244, and the antenna 246) may comprise means for determining the one or more parameters, and the processor 510, possibly in combination with the memory 530, in combination with the transceiver 520 (e.g., the wireless transmitter 242 and the antenna 246) may comprise means for reporting that the primary UE is within the threshold distance of the target UE. In another example implementation, the one or more parameters are indicative of the proximity of the target UE to the primary UE, and the method 1500 further comprises reporting, by the target UE to a network entity, the position information for the target UE regardless of the proximity of the target UE to the primary UE. For example, at sub-stage 1224 the target UE 1201 may determine whether the primary UE 1203 is within an acceptable proximity of the target UE 1201, and the target UE 1201 may report the position information 1238 to the network entity 1202 whether or not the primary UE 1203 is within an acceptable proximity of the target UE 1201, e.g., based on an instruction in the location request 1212.

Also or alternatively, implementations of the method 1500 may include one or more of the following features. In an example implementation, the target UE includes the plurality of UE SIMs including a first SIM and a second SIM, and the method 1500 further comprises transmitting a message to the target UE from a network entity indicating that assistance data for the first SIM is applicable to the second SIM. For example, the network entity 702 may include an indication in the assistance data 726 that the assistance data is applicable to both of the SIMs 591, 592. The processor 610, possibly in combination with the memory 630, in combination with the transceiver 620 (e.g., a wired transmitter, or a wireless transmitter and an antenna) may comprise means for transmitting the message to the target UE. In another example implementation, the one or more parameters are indicative of the cost to perform the one or more positioning operations, and selecting the device to perform the one or more positioning operations comprises selecting the device to perform sidelink signal transfer with the target UE (e.g., transmit a sidelink signal to the target UE and/or receive a sidelink signal from the target UE). The device selection unit 570 may select one or more peer UEs for SL-PRS transfer with the UE 500. e.g., based on the peer UE(s) that is(are) in SL range of the UE 500 and available and willing to perform SL-PRS transfer (and possibly one or more other positioning operations). The processor 510, possibly in combination with the memory 530, may comprise means for selecting the device to perform sidelink signal transfer with the target UE. Also or alternatively, the processor 610, possibly in combination with the memory 630, may comprise means for selecting the device to perform sidelink signal transfer with the target UE if the network entity 600 is provided with information regarding which peer UEs are within sidelink range of the target UE and are available and willing to perform one or more positioning operations for positioning of the target UE.

### Implementation Examples

Implementation examples are provided in the following numbered clauses.

1. A device selection method for positioning, the method comprising:
determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
selecting, based on the one or more parameters, a device to perform the one or more positioning operations.

2. The method of clause 1, wherein the one or more parameters are indicative of the cost to perform the one or more positioning operations, and wherein the cost to perform one or more position operations comprises a monetary cost.

3. The method of clause 1, wherein the one or more parameters are indicative of the cost to perform the one or more positioning operations, and wherein the cost to perform one or more position operations comprises a power consumption of the target UE.

4. The method of clause 1, wherein:
the one or more parameters are indicative of the cost to perform the one or more positioning operations;
the method further comprises receiving, at a network entity from the target UE, an indication that the target UE includes the plurality of UE SIMs; and
selecting the device to perform the one or more positioning operations comprises routing a location request to one of the plurality of UE SIMs.

5. The method of clause 4, wherein the one or more parameters are indicative of whether each of the plurality of UE SIMs, that are included in the target UE, is in an idle mode or an inactive mode or a connected mode, and wherein the location request is routed to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

6. The method of clause 1, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

7. The method of clause 6, wherein the target UE includes the plurality of UE SIMs including a first SIM and a second SIM, and wherein selecting the device to perform the one or more positioning operations comprises selecting the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

8. The method of clause 1, wherein determining the one or more parameters comprises the target UE determining that the primary UE is within a threshold distance of the target UE, and wherein the method further comprises reporting, from the target UE to a network entity, that the primary UE is within the threshold distance of the target UE.

9. The method of clause 1, wherein the one or more parameters are indicative of the proximity of the target UE to the primary UE, and wherein the method further comprises reporting, by the target UE to a network entity, the position information for the target UE regardless of the proximity of the target UE to the primary UE.

10. The method of clause 1, wherein the target UE includes the plurality of UE SIMs including a first SIM and a second SIM, and wherein the method further comprises transmitting a message to the target UE from a network entity indicating that assistance data for the first SIM is applicable to the second SIM.

11. The method of clause 1, wherein the one or more parameters are indicative of the cost to perform the one or more positioning operations, and wherein selecting the device to perform the one or more positioning operations comprises selecting the device to perform sidelink signal transfer with the target UE.

12. An apparatus comprising:
a transceiver;
a memory; and
a processor communicatively coupled to the transceiver and the memory and configured to:
determine one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
select, based on the one or more parameters, a device to perform the one or more positioning operations.

13. The apparatus of clause 12, wherein the one or more parameters are indicative of the cost to perform the one or more positioning operations, and wherein the cost to perform one or more position operations comprises a monetary cost.

14. The apparatus of clause 12, wherein the one or more parameters are indicative of the cost to perform the one or more positioning operations, and wherein the cost to perform one or more position operations comprises a power consumption of the target UE.

15. The apparatus of clause 12, wherein:
the one or more parameters are indicative of the cost to perform the one or more positioning operations;
the apparatus comprises a network entity and the processor is configured to receive, from the target UE via the transceiver, an indication that the target UE includes the plurality of UE SIMs; and
to select the device to perform the one or more positioning operations the processor is configured to route a location request to one of the plurality of UE SIMs.

16. The apparatus of clause 15, wherein the one or more parameters are indicative of whether each of the plurality of UE SIMs, that are included in the target UE, is in an idle mode or an inactive mode or a connected mode, and wherein the processor is configured to route the location request to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

17. The apparatus of clause 12, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

18. The apparatus of clause 17, wherein the target UE includes the plurality of UE SIMs including a first SIM and a second SIM, and wherein to select the device to perform the one or more positioning operations the processor is configured to select the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

19. The apparatus of clause 12, wherein the apparatus comprises the target UE, wherein to determine the one or more parameters the processor is configured to determine that the primary UE is within a threshold distance of the target UE, and wherein the processor is configured to report, via the transceiver to a network entity, that the primary UE is within the threshold distance of the target UE.

20. The apparatus of clause 12, wherein the apparatus comprises the target UE, wherein the one or more parameters are indicative of the proximity of the target UE to the primary UE, and wherein the processor is configured to report, via the transceiver to a network entity, the position information for the target UE regardless of the proximity of the target UE to the primary UE.

21. The apparatus of clause 12, wherein the apparatus comprises a network entity, wherein the target UE includes the plurality of UE SIMs including a first SIM and a second SIM, and wherein the processor is configured to transmit, via the transceiver to the target UE, a message indicating that assistance data for the first SIM is applicable to the second SIM.

22. The apparatus of clause 12, wherein the one or more parameters are indicative of the cost to perform the one or more positioning operations, and wherein to select the device to perform the one or more positioning operations the processor is configured to select the device to perform sidelink signal transfer with the target UE.

23. An apparatus comprising:
means for determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
means for selecting, based on the one or more parameters, a device to perform the one or more positioning operations.

24. The apparatus of clause 23, wherein the one or more parameters are indicative of the cost to perform the one or more positioning operations, and wherein the cost to perform one or more position operations comprises a monetary cost.

25. The apparatus of clause 23, wherein the one or more parameters are indicative of the cost to perform the one or more positioning operations, and wherein the cost to perform one or more position operations comprises a power consumption of the target UE.

26. The apparatus of clause 23, wherein:
the one or more parameters are indicative of the cost to perform the one or more positioning operations;
the apparatus comprises a network entity and further comprises means for receiving, from the target UE, an indication that the target UE includes the plurality of UE SIMs; and
the means for selecting the device to perform the one or more positioning operations comprises means for routing a location request to one of the plurality of UE SIMs.

27. The apparatus of clause 26, wherein the one or more parameters are indicative of whether each of the plurality of UE SIMs, that are included in the target UE, is in an idle mode or an inactive mode or a connected mode, and wherein the means for routing the location request comprise means for routing the location request to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

28. The apparatus of clause 23, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

29. The apparatus of clause 28, wherein the target UE includes the plurality of UE SIMs including a first SIM and a second SIM, and wherein the means for selecting the device to perform the one or more positioning operations comprises means for selecting the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

30. The apparatus of clause 23, wherein the means for determining the one or more parameters comprises means for determining that the primary UE is within a threshold distance of the target UE, and wherein the apparatus further comprises means for reporting, to a network entity, that the primary UE is within the threshold distance of the target UE.

31. The apparatus of clause 23, wherein the one or more parameters are indicative of the proximity of the target UE to the primary UE, and wherein the apparatus further comprises means for reporting, to a network entity, the position information for the target UE regardless of the proximity of the target UE to the primary UE.

32. The apparatus of clause 23, wherein the target UE includes the plurality of UE SIMs including a first SIM and a second SIM, and wherein the apparatus further comprises means for transmitting a message, to the target UE, indicating that assistance data for the first SIM is applicable to the second SIM.

33. The apparatus of clause 23, wherein the one or more parameters are indicative of the cost to perform the one or more positioning operations, and wherein the means for selecting the device to perform the one or more positioning operations comprises means for selecting the device to perform sidelink signal transfer with the target UE.

34. A non-transitory, processor-readable storage medium comprising processor-readable instructions to cause a processor of an apparatus to:
determine one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
select, based on the one or more parameters, a device to perform the one or more positioning operations.

35. The storage medium of clause 34, wherein the one or more parameters are indicative of the cost to perform the one or more positioning operations, and wherein the cost to perform one or more position operations comprises a monetary cost.

36. The storage medium of clause 34, wherein the one or more parameters are indicative of the cost to perform the one or more positioning operations, and wherein the cost to perform one or more position operations comprises a power consumption of the target UE.

37. The storage medium of clause 34, wherein:
the one or more parameters are indicative of the cost to perform the one or more positioning operations;
the apparatus comprises a network entity and the storage medium further comprises processor-readable instructions to cause the processor to receive, from the target UE, an indication that the target UE includes the plurality of UE SIMs; and
the processor-readable instructions to cause the processor to select the device to perform the one or more positioning operations comprise processor-readable instructions to cause the processor to route a location request to one of the plurality of UE SIMs.

38. The storage medium of clause 37, wherein the one or more parameters are indicative of whether each of the plurality of UE SIMs, that are included in the target UE, is in an idle mode or an inactive mode or a connected mode, and wherein the processor-readable instructions to cause the processor to route the location request comprise processor-readable instructions to cause the processor to route the location request to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

39. The storage medium of clause 34, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

40. The storage medium of clause 39, wherein the target UE includes the plurality of UE SIMs including a first SIM and a second SIM, and wherein the processor-readable instructions to cause the processor to select the device to perform the one or more positioning operations comprise processor-readable instructions to cause the processor to select the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

41. The storage medium of clause 34, wherein the processor-readable instructions to cause the processor to determine the one or more parameters comprise processor-readable instructions to cause the processor to determine that the primary UE is within a threshold distance of the target UE, and wherein the storage medium further comprises processor-readable instructions to cause the processor to report, to a network entity, that the primary UE is within the threshold distance of the target UE.

42. The storage medium of clause 34, wherein the one or more parameters are indicative of the proximity of the target UE to the primary UE, and wherein the storage medium further comprises processor-readable instructions to cause the processor to report, to a network entity, the position information for the target UE regardless of the proximity of the target UE to the primary UE.

43. The storage medium of clause 34, wherein the target UE includes the plurality of UE SIMs including a first SIM and a second SIM, and wherein the storage medium further comprises processor-readable instructions to cause the processor to transmit a message, to the target UE, indicating that assistance data for the first SIM is applicable to the second SIM.

44. The storage medium of clause 34, wherein the one or more parameters are indicative of the cost to perform the one or more positioning operations, and wherein the processor-readable instructions to cause the processor to select the device to perform the one or more positioning operations comprise processor-readable instructions to cause the processor to select the device to perform sidelink signal transfer with the target UE.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises.” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, the term RS (reference signal) may refer to one or more reference signals and may apply, as appropriate, to any form of the term RS, e.g., PRS. SRS, CSI-RS, etc.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A. B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices (also called wireless communications devices). A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A device selection method for positioning, the method comprising:
determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
selecting, based on the one or more parameters, a device to perform the one or more positioning operations.

2. The method of claim 1, wherein the one or more parameters are indicative of the cost to perform the one or more positioning operations, and wherein the cost to perform one or more position operations comprises a monetary cost.

3. The method of claim 1, wherein the one or more parameters are indicative of the cost to perform the one or more positioning operations, and wherein the cost to perform one or more position operations comprises a power consumption of the target UE.

4. The method of claim 1, wherein:
the one or more parameters are indicative of the cost to perform the one or more positioning operations;
the method further comprises receiving, at a network entity from the target UE, an indication that the target UE includes the plurality of UE SIMs; and
selecting the device to perform the one or more positioning operations comprises routing a location request to one of the plurality of UE SIMs.

5. The method of claim 4, wherein the one or more parameters are indicative of whether each of the plurality of UE SIMs, that are included in the target UE, is in an idle mode or an inactive mode or a connected mode, and wherein the location request is routed to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

6. The method of claim 1, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

7. The method of claim 6, wherein the target UE includes the plurality of UE SIMs including a first SIM and a second SIM, and wherein selecting the device to perform the one or more positioning operations comprises selecting the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

8. The method of claim 1, wherein determining the one or more parameters comprises the target UE determining that the primary UE is within a threshold distance of the target UE, and wherein the method further comprises reporting, from the target UE to a network entity, that the primary UE is within the threshold distance of the target UE.

9. The method of claim 1, wherein the one or more parameters are indicative of the proximity of the target UE to the primary UE, and wherein the method further comprises reporting, by the target UE to a network entity, the position information for the target UE regardless of the proximity of the target UE to the primary UE.

10. The method of claim 1, wherein the target UE includes the plurality of UE SIMs including a first SIM and a second SIM, and wherein the method further comprises transmitting a message to the target UE from a network entity indicating that assistance data for the first SIM is applicable to the second SIM.

11. The method of claim 1, wherein the one or more parameters are indicative of the cost to perform the one or more positioning operations, and wherein selecting the device to perform the one or more positioning operations comprises selecting the device to perform sidelink signal transfer with the target UE.

12. An apparatus comprising:
a transceiver;
a memory; and
a processor communicatively coupled to the transceiver and the memory and configured to:
determine one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
select, based on the one or more parameters, a device to perform the one or more positioning operations.

13. The apparatus of claim 12, wherein the one or more parameters are indicative of the cost to perform the one or more positioning operations, and wherein the cost to perform one or more position operations comprises a monetary cost.

14. The apparatus of claim 12, wherein the one or more parameters are indicative of the cost to perform the one or more positioning operations, and wherein the cost to perform one or more position operations comprises a power consumption of the target UE.

15. The apparatus of claim 12, wherein:
the one or more parameters are indicative of the cost to perform the one or more positioning operations;
the apparatus comprises a network entity and the processor is configured to receive, from the target UE via the transceiver, an indication that the target UE includes the plurality of UE SIMs; and
to select the device to perform the one or more positioning operations the processor is configured to route a location request to one of the plurality of UE SIMs.

16. The apparatus of claim 15, wherein the one or more parameters are indicative of whether each of the plurality of UE SIMs, that are included in the target UE, is in an idle mode or an inactive mode or a connected mode, and wherein the processor is configured to route the location request to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

17. The apparatus of claim 12, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

18. The apparatus of claim 17, wherein the target UE includes the plurality of UE SIMs including a first SIM and a second SIM, and wherein to select the device to perform the one or more positioning operations the processor is configured to select the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

19. The apparatus of claim 12, wherein the apparatus comprises the target UE, wherein to determine the one or more parameters the processor is configured to determine that the primary UE is within a threshold distance of the target UE, and wherein the processor is configured to report, via the transceiver to a network entity, that the primary UE is within the threshold distance of the target UE.

20. The apparatus of claim 12, wherein the apparatus comprises the target UE, wherein the one or more parameters are indicative of the proximity of the target UE to the primary UE, and wherein the processor is configured to report, via the transceiver to a network entity, the position information for the target UE regardless of the proximity of the target UE to the primary UE.

21. The apparatus of claim 12, wherein the apparatus comprises a network entity, wherein the target UE includes the plurality of UE SIMs including a first SIM and a second SIM, and wherein the processor is configured to transmit, via the transceiver to the target UE, a message indicating that assistance data for the first SIM is applicable to the second SIM.

22. The apparatus of claim 12, wherein the one or more parameters are indicative of the cost to perform the one or more positioning operations, and wherein to select the device to perform the one or more positioning operations the processor is configured to select the device to perform sidelink signal transfer with the target UE.

23. An apparatus comprising:
means for determining one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
means for selecting, based on the one or more parameters, a device to perform the one or more positioning operations.

24. The apparatus of claim 23, wherein the one or more parameters are indicative of the cost to perform the one or more positioning operations, and wherein the cost to perform one or more position operations comprises a monetary cost.

25. The apparatus of claim 23, wherein the one or more parameters are indicative of the cost to perform the one or more positioning operations, and wherein the cost to perform one or more position operations comprises a power consumption of the target UE.

26. The apparatus of claim 23, wherein:
the one or more parameters are indicative of the cost to perform the one or more positioning operations;
the apparatus comprises a network entity and further comprises means for receiving, from the target UE, an indication that the target UE includes the plurality of UE SIMs; and
the means for selecting the device to perform the one or more positioning operations comprises means for routing a location request to one of the plurality of UE SIMs.

27. The apparatus of claim 26, wherein the one or more parameters are indicative of whether each of the plurality of UE SIMs, that are included in the target UE, is in an idle mode or an inactive mode or a connected mode, and wherein the means for routing the location request comprise means for routing the location request to a first SIM of the plurality of UE SIMs based on the one or more parameters indicating that the first SIM of the plurality of UE SIMs is in the connected mode and that a second SIM of the plurality of UE SIMs is in the idle mode or the inactive mode, or that the first SIM of the plurality of UE SIMs is in the inactive mode and that the second SIM of the plurality of UE SIMs is in the idle mode.

28. The apparatus of claim 23, wherein the one or more parameters are indicative of the cost to perform the one or more positioning operations, and wherein the one or more parameters are indicative, for each of the plurality of UE SIMs, of a respective idle mode discontinuous reception configuration and a respective positioning reference signal configuration.

29. The apparatus of claim 28, wherein the target UE includes the plurality of UE SIMs including a first SIM and a second SIM, and wherein the means for selecting the device to perform the one or more positioning operations comprises means for selecting the first SIM to perform the one or more positioning operations based on the one or more parameters indicating that the first SIM and the second SIM are both in an idle mode, or both in an inactive mode, and indicating either that a first wake-up time of the first SIM includes a first arrival time of a first positioning reference signal configuration for the first SIM or is closer to the first arrival time of the first positioning reference signal configuration for the first SIM than a second wake-up time of the second SIM is to a second arrival time of a second positioning reference signal configuration for the second SIM.

30. A non-transitory, processor-readable storage medium comprising processor-readable instructions to cause a processor of an apparatus to:
determine one or more parameters, corresponding to a plurality of user equipment subscriber identity modules (UE SIMs), indicative of a cost to perform one or more positioning operations for determining position information for a target UE, or indicative of a proximity of the target UE to a primary UE that contains at least one of the plurality of UE SIMs; and
select, based on the one or more parameters, a device to perform the one or more positioning operations.
